(19) United States
(12) Patent Application Publication
(10) Pub. No.: US 2007/0251105 A1
(43) Pub. Date: Nov. 1, 2007

(54) ELECTRIC PENCIL SHARPENER

(75) Inventor: Tokinori TAKADA, Chiba pref. (JP)

Correspondence Address: ROGER PITT;KIRKPATRICK & LOCKHART PRESTON GATES ELLIS LLP, 599 LEXINGTON AVENUE, 33RD FLOOR, NEW YORK, NY, 10022-6030, US

(73) Assignee: KTF CORPORATION, TOKYO (JP)

(21) Appl. No.: 11/627,669

(22) Filed: Jan. 26, 2007

(30) Foreign Application Priority Data
Apr. 27, 2006 (JP) 2006-123479

(51) Int. Cl. B43L 23/00

(52) U.S. Cl. 30/454

(57) ABSTRACT

An electric pencil sharpener comprises a wasteful shaving prevention mechanism for separating the rotatable cutting blade from the pencil a pencil-core tip adjustment mechanism for adjusting the diameter of the shaved pencil-core tip, and a core fragment removal mechanism for removing any broken off pencil-core fragment remaining in the electric pencil sharpener. The wasteful shaving prevention mechanism includes the cutting blade, a cutter shaft and a plate and is structured to separate the cutting blade from the pencil when sharpening if finished. The pencil-core tip adjustment mechanism includes a pencil-core tip adjustment dial, a rotatable pencil-core tip adjustment screw, a gear shaft, a connecting rod, a plate and a stop. The core fragment removal mechanism includes a button, a gear shaft, a connecting rod, a plate and a stop. An electric pencil sharpener that further incorporates a pencil diameter adapter is also provided.

### BACKGROUND OF THE INVENTION

1. Field of the Invention

The present invention relates to an electric pencil sharpener that uses electric power to shave the tip of a pencil, particularly an electric pencil sharpener with enhanced functions including pencil-core tip adjustment capability, core fragment removal capability and wasteful shaving prevention capability, and further relates to an electric pencil sharpener equipped with a pencil diameter adapter.

2. Description of Related Art

Electric pencil sharpeners, which are widely used in both the home and office, are today in greater demand than the conventional manual pencil sharpener. The mainstream in pencil sharpeners is now the functionally enhanced electric pencil sharpener. Although rechargeable and dry battery sharpeners that offer high mobility are also available, development of multifunctional AC-powered electric pencil sharpener responsive to various requirements continues to move forward.

One feature added to the electric pencil sharpener is the wasteful shaving prevention function for stopping the shaving operation when sharpening is finished. This feature is implemented by either the method of shutting off the driving power when sharpening is complete or the method of separating the cutting blade from the pencil when the sharpening is complete.

Another added feature considered necessary is pencil-core tip adjustment capability for enabling adjustment of the core tip diameter by operating an external dial or the like to bring a fore-aft movable contact piece into contact with the tip of the core. Still another is core fragment removal capability for enabling one-touch removal of pencil-core remnants broken off from the core tip during rotational shaving.

While removal of a broken off piece of pencil-core from a hand-operated pencil sharpener can become quite an ordeal for the lack of any standard procedure for achieving this end, removal from an electric pencil sharpener is even more troublesome. This is because an electric pencil sharpener may suffer ill effects if picked up and turned over, and if the broken-off core piece should become lodged deep inside the sharpener, the situation becomes hopeless, i.e., the sharpener can no longer be operated. Moreover, improvement of pencil sharpener performance does not eliminate the possibility of pencil-core fragments remaining inside. In other words, this is not a problem that can be overcome by enhancing pencil sharpener performance but a problem that inevitably occurs because of various related factors, such as the pencil-core hardness, defects occurring during pencil manufacture, and impacts imparted in the course of use as when, for example, the writer drops the pencil.

Although some existing electric pencil sharpeners are equipped with a wasteful shaving prevention mechanism utilizing the method of shutting off the driving power when sharpening is complete and with pencil-core tip adjustment and core fragment removal mechanisms, they are inconvenient in the point of producing a rough shaved surface owing to the sudden shutoff of driving power when sharpening is finished.

A pencil sharpener with pencil-core adjustment capability is taught by Japanese Laid-open Patent Application No. 2003-154791 (Ref No. 1), a sharpener with pencil-core tip adjustment capability and wasteful shaving prevention capability utilizing the method of cutting blade separation is taught by Japanese Laid-open Patent Application No. Hei 6-210995 (Ref No. 2), and an electric pencil sharpener equipped with pencil-core ejection means is taught by Assignee's Japanese Patent No. 3505144 (Ref No. 3).

However, considerably complexity is encountered in providing a single electric pencil sharpener with all of these capabilities, i.e., the wasteful shaving prevention capability utilizing the method of stopping the cutting operation by cutting blade separation, the pencil-core tip adjustment capability, and the core fragment removal capability by pencil-core ejection, and, therefore, no electric pencil sharpener incorporating all of the capabilities in a single unit has been available heretofore.

Since the provision of multiple features in a sharpener tends to increase both weight and overall size, and also increases cost, a need has been felt for the development of an inexpensive sharpener of simple structure that incorporates all of the functions required by customers with no increase in size or weight relative to those of the conventional sharpener.

### SUMMARY OF THE INVENTION

An object of the present invention is to solve the foregoing issues by providing an electric pencil sharpener that achieves the functions heretofore realized by incorporation of independent mechanisms for wasteful shaving prevention, pencil-core tip adjustment and core fragment removal by means of an integrated structure that achieves all of the functions interoperatively. Another object of the present invention is to provide an electric pencil sharpener having a pencil diameter adapter.

In order to achieve these objects, the present invention provides an electric pencil sharpener comprising a main unit cover, an electrically powered drive mechanism, a rotation transmission mechanism, a cutting mechanism equipped with a rotary cutting blade for rotationally shaving a pencil, a wasteful shaving prevention mechanism for separating the rotary cutting blade from the pencil, a pencil-core tip adjustment mechanism for adjusting the diameter of the shaved pencil-core tip, and a core fragment removal mechanism for removing from the pencil sharpener any broken off pencil-core fragment remaining therein, in which electric pencil sharpener: the wasteful shaving prevention mechanism includes a slidable cutting blade for obliquely contacting an inserted pencil to shave it from its tip end while executing planetary rotation, a cutter shaft constituting the cutting blade center shaft and a plate contacted by the distal end of the cutter shaft; the pencil-core tip adjustment mechanism includes a pencil-core tip adjustment dial provided on the outer surface of the main unit cover for enabling selection of a pencil-core tip length, a pencil-core tip adjustment screw rotated by rotation of the dial, a gear shaft screw-engaged with the pencil-core tip adjustment screw to be movable in the axial direction, a connecting rod connected to the end of the gear shaft, a swing plate provided on the end of the connecting rod and a stop equipped with a contact piece that engages the base of the swing plate to cause the distal end thereof to contact the pencil-core tip; and the core fragment removal mechanism includes a core fragment removal button provided on the outer surface of the main unit cover, said gear shaft fit into the pencil-core tip adjustment screw and structured to slide as a whole in response to pressing of the button, said connecting rod connected to the end of said gear shaft, said swing plate provided on the end of the connecting rod and said stop equipped with the contact piece that engages the base of said swing plate to cause the distal end thereof to contact the pencil-core tip.

The present invention also provides an electric pencil sharpener comprising a main unit cover, an electrically powered drive mechanism, a rotation transmission mechanism, a cutting mechanism equipped with a rotary cutting blade for rotationally shaving a pencil, a wasteful shaving prevention mechanism for separating the rotary cutting blade from the pencil, a pencil-core tip adjustment mechanism for adjusting the diameter of the shaved pencil-core tip, and a core fragment removal mechanism for removing from the pencil sharpener any broken off pencil-core fragment remaining therein, in which electric pencil sharpener: the pencil-core tip adjustment mechanism and the core fragment removal mechanism are constituted as a unitary structure including a pencil-core tip adjustment knob structured to be both rotatable and depressible, an engagement member pressed by the distal end portion of the pencil-core tip adjustment knob, a shaft in turn pressed by the pressed engagement member, a plate that operates as a lever fixed at one point, and a laterally movable stop pressed by the lower end of the plate pressed by said shaft.

The present invention also provides an electric pencil sharpener wherein the wasteful shaving prevention mechanism has a structure whereby even when rotation of the pencil-core tip adjustment dial causes rotation of a pencil-core tip adjustment gear (formed integrally with a pencil-core tip adjustment internal gear), the gear shaft itself is moved to move the connecting rod, so that movement of the gear shaft moves the connecting rod to press the swinging end of the swing plate provided on the end of the connecting rod and interoperatively move the shaft of the cutting blade and thus move the cutting blade upward to separate the cutting blade from the shaved surface of the pencil being shaved, thereby preventing wasteful shaving.

The present invention also provides an electric pencil sharpener wherein the pencil-core tip adjustment screw of the pencil-core tip adjustment mechanism is formed at its center with a threaded through-hole and the gear shaft is fit in the hollow through-hole to be movable in the axial direction.

The present invention also provides an electric pencil sharpener wherein the core fragment removal mechanism has a structure whereby pressing of the core fragment removal button turns power ON to cause a motor to rotate a cutter holder, thereby rotating the cutting blade to push any residual matter toward a pencil insertion hole and thus cause the residual matter to be propelled toward the pencil insertion hole.

The present invention also provides an electric pencil sharpener comprising a main unit cover, an electrically powered drive mechanism, a rotation transmission mechanism, a cutting mechanism equipped with a cutting blade for rotationally shaving a pencil, a wasteful shaving prevention mechanism for separating the rotary cutting blade from the pencil, a pencil-core tip adjustment mechanism for adjusting the diameter of the shaved pencil-core tip, and a core fragment removal mechanism for removing from the pencil sharpener any broken off pencil-core fragment remaining therein, which electric pencil sharpener further comprises a switchbox capable of detecting an inserted pencil and including a substantially L-shaped pencil insertion zone switch lever adapted to be pushed horizontally by an inserted pencil and having a perforated section formed with a hole and a switch lever projection, a switch plate formed with a projection and adapted to press a switch terminal when pushed by the switch lever projection, a switch adapted to be turned ON to supply power when the terminal thereof is pressed by the switch plate, a shaving bin detector that presses the switch plate projection of the pencil insertion zone switch lever from underneath, and a switch lever formed with a switch lever taper, one end of which is inserted into the perforated section of the pencil insertion zone switch lever and the other end of which is taperedly cut away and pressed by a switch shaft to move vertically. The perforated section of the pencil insertion zone switch lever can have a generally triangular shape.

The present invention also provides an electric pencil sharpener comprising a main unit cover, an electrically powered drive mechanism, a rotation transmission mechanism, and a cutting mechanism equipped with a rotary cutting blade for rotationally shaving a pencil, which electric pencil sharpener further comprises a pencil diameter adapter enabling true center sharpening irrespective of the thickness of an inserted pencil, the pencil diameter adapter including slide plates formed with projections and adapted to press the pencil from three directions, an adapter plate provided with arcuate engagement slots of the same arc angle whose centers are offset from one another and which are arranged to receive insertion of the projections formed on the slide plates and is provided at its upper end with a sector gear for engagement with a gear of a shaft, and the shaft formed with the gear for engagement with the sector gear.

The portions of the slide plates that press the pencil can be flat plates that can be made to assume a curved shape matched to the diameter of the pencil.

Owing to the structure explained in the foregoing, the electric pencil sharpener according to the present invention offers the following merits:

1. Although the provision of the core fragment removal mechanism inside the pencil-core tip adjustment mechanism somewhat complicates the internal structure, the overall size and ease of use are comparable to those the conventional sharpener and cost is held to a low level. In addition, the conventional wasteful shaving prevention mechanism is incorporated without modification, so that the advantages of the conventional sharpener, specifically that the power is not turned OFF when the diameter of the pencil-core tip reaches a predetermined size and that the pencil is not made hard to extract by the cutting blade biting into the pencil, are also thoroughly built in.

### 2. Since the pencil-core tip adjustment mechanism and core fragment removal mechanism are formed using a single common screw member, the sharpener has a simple structure as a whole and can be made compact by simplifying its internal structure.

### 3. Since the wasteful shaving prevention mechanism is provided as a standard feature, the electric pencil sharpener does not sacrifice any advantages despite being multifunctional.

4. The electric pencil sharpener enables fine adjustment of the pencil core-tip thanks to the provision of the through-hole at the center of the pencil-core tip adjustment screw of the pencil-core tip adjustment mechanism so as to establish a structure that enables the gear shaft to move freely in the axial direction.
5. Although the fact that the structure of the core fragment removal mechanism is such that the pencil-core tip adjustment screw and gear shaft of the pencil-core tip adjustment mechanism move as a whole when the button is pressed makes the structure of the electric pencil sharpener somewhat complex, a product can be provided that remains unchanged overall in the general configuration of the electric pencil sharpener and that has the advantages of being compact and inexpensive for its broad range of functions. In addition, a pencil stub, broken off core fragment or other remaining object can be removed.

### 6. The switchbox for sensing pencil insertion enables operation with a simplified structure, thus enabling size reduction.

### 7. The substantially triangular shape of the perforated section establishes play at the contact surface, thereby ensuring reliable operation.

### 8. The slide plate, adapter plate and adjustment lever make it possible to conduct true center pencil sharpening.

### 9. Since the surface of the slide plate that makes contact with the pencil is a flat plate that can be imparted with curvature, the pencil can be reliably retained.

### BRIEF DESCRIPTION OF THE DRAWINGS

FIG. 1(a) is an overall perspective view of the main unit cover of an electric pencil sharpener that is an embodiment of the invention.

FIG. 1(b) is an overall plan view of the electric pencil sharpener.

FIG. 2 is an exploded sectional view of the electric pencil sharpener seen from the side.

FIG. 3 is an exploded view of the electric pencil sharpener showing a pencil-core tip adjustment mechanism moved to a thick setting.

FIG. 4(a) is an exploded view showing specific components.

FIG. 4(b) is an exploded view showing specific components.

FIG. 4(c) is an exploded view showing specific components.

FIG. 4(d) is an exploded view showing specific components.

FIG. 4(e) is an exploded view showing specific components.

FIG. 5 is a sectional view showing an electric pencil sharpener that is another embodiment of the invention.

FIG. 6 is diagram showing the structure of a switchbox of the electric pencil sharpener.

FIG. 7 is a side view for explaining a taper of a switch lever of the switchbox of the electric pencil sharpener.

FIG. 8(a) is a diagram for explaining the structure of a pencil diameter adapter of the electric pencil sharpener.

FIG. 8(b) is an exploded view of the pencil diameter adapter.

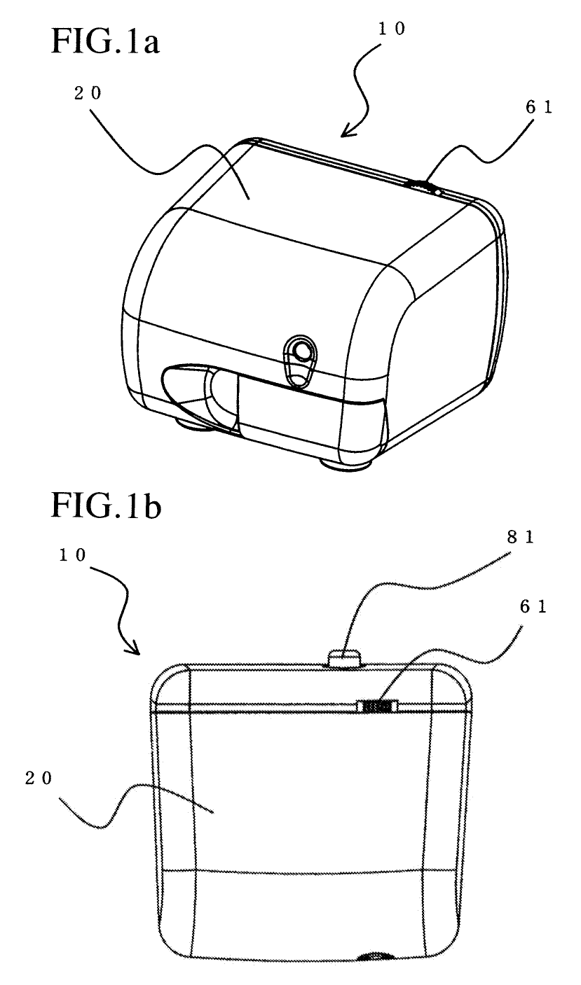

### DESCRIPTION OF THE PREFERRED EMBODIMENTS

The electric pencil sharpener according to the invention will now be explained in detail with reference to preferred embodiments illustrated in the drawings.

The invention electric pencil sharpener, designated by the symbol 10, comprises a main unit cover 20, a drive mechanism 30, transmission mechanism 40, cutting mechanism 50, pencil-core tip adjustment mechanism 60, wasteful shaving prevention mechanism 70, and core fragment removal mechanism 80.

### First Embodiment

The main unit cover 20 has an overall box-like shape. A pencil-core tip adjustment dial 61 and a button 81 of the core fragment removal mechanism 80 are provided to project outward of the surface of the main unit cover 20. A pencil insertion hole is formed at a location opposite that of the button of the core fragment removal mechanism.

The drive mechanism, transmission mechanism, cutting mechanism, pencil-core tip adjustment mechanism, wasteful shaving prevention mechanism and core fragment removal mechanism are accommodated inside the main unit cover.

The drive mechanism 30 comprises a drive device 32 and an electric power supply unit 34. The drive device 32 is a motor in this embodiment. A gear is fitted on the output shaft of the motor. Power is transmitted from the motor 32 to the transmission mechanism 40 through this gear. In this embodiment, the electric power supply unit 34 is an ac power source but can instead be a dc power source.

The drive mechanism is equipped with a switch that projects inward from the inner wall of the pencil insertion hole. The switch turns ON the power to operate the pencil sharpener when pressed by a pencil inserted in the insertion hole.

The transmission mechanism 40, which comprises a number of gears, transmits power from the drive mechanism 30 to the cutting mechanism 50. The particulars of the transmission mechanism 40 have no bearing on the essence of the invention and will not be explained in detail. Suffice it to say that the transmission mechanism 40 uses gears to supply rotary motion to and rotate the cutting blade so as to shave a pencil rotationally.

The cutting mechanism 50 is a cylindrical cutter constituted of a cutting blade 52 helically provided on the outside of a cylindrical body. A cutter shaft 54 is inserted into the cylindrical body. The cutting blade 52 is brought into oblique contact with a pencil 12 to be sharpened while maintaining a shaving angle with respect to the pencil. It rotates about its own axis to shave the tip of the pencil rotationally while also executing planetary rotation around the pencil.

The cutter shaft 54 is installed at an inclination with respect to the pencil 12.

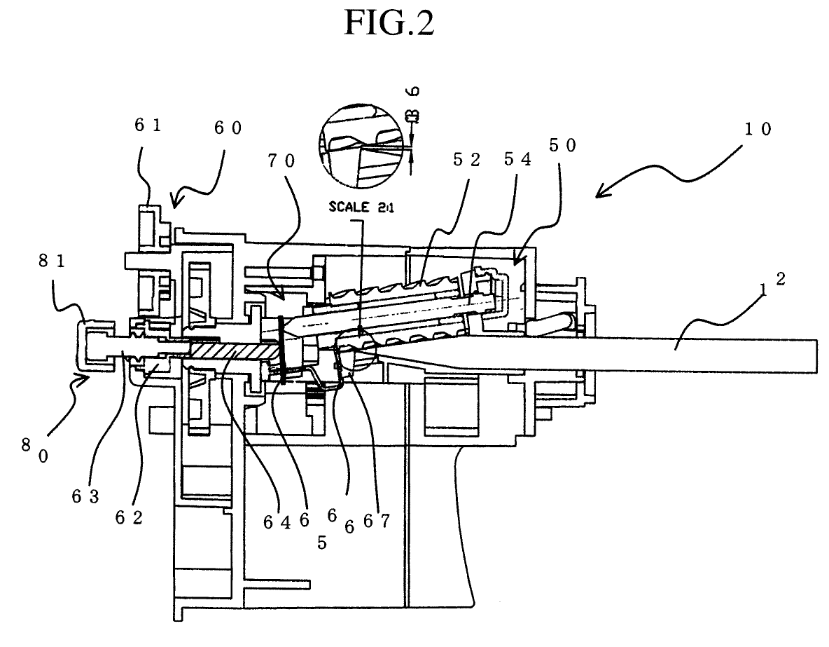

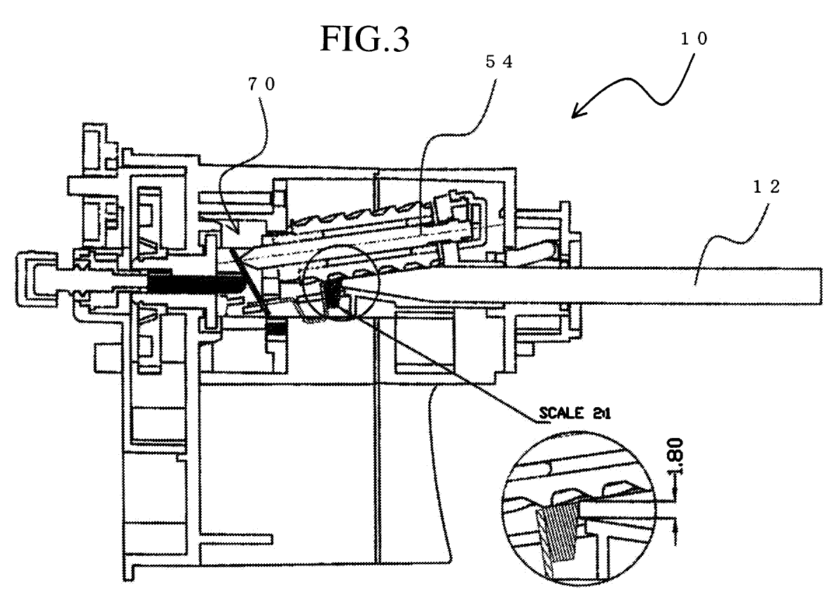

The electric pencil sharpener according to a first embodiment will be explained with reference to FIGS. 2 and 3. The electric pencil sharpener of this embodiment is equipped with the pencil-core tip adjustment mechanism 60, wasteful shaving prevention mechanism 70 and core fragment removal mechanism 80.

The pencil-core tip adjustment mechanism 60 comprises the pencil-core tip adjustment dial 61 provided on the outer surface of the main unit cover and used to select desired pencil-core length and thickness, a gear shaft 63 engaged with a pencil-core tip adjustment screw 62 and rotated to move laterally with rotation of the dial, a connecting rod 64 connected to the tip of the gear shaft 63, a swing plate 65 provided to be swingable at the tip of the connecting rod, and a stop 66 for stopping the pencil-core whose base is engaged with the swing plate and whose tip is provided with a contact piece 67 that contacts the pencil-core tip.

In this embodiment, when the pencil-core tip adjustment dial 61 is turned to set a suitable pencil-core length, the pencil-core tip adjustment screw 62, which engages (meshes with) the dial within its rotating range, rotates to cause the gear shaft 63 engaged therewith to move laterally. As a result, the connecting rod 64 connected to the tip of the gear shaft also moves laterally in response. Alternatively, the pencil-core tip adjustment dial 61 can be of the sliding type.

The gear shaft 63 and the pencil-core tip adjustment screw 62 into which it is screwed are constituted by cutting a through-hole having a threaded inner wall at the axial center of the pencil-core tip adjustment screw 62 and screwing the gear shaft 63 into the axially centered through-hole so as to be free to rotate. Rotation of the pencil-core tip adjustment screw 62 moves the gear shaft 63 in the axial direction of the gear (gear shaft).

The wasteful shaving prevention mechanism 70 comprises the cutting blade 52 that comes into oblique contact with the pencil and shaves the tip of the pencil while executing planetary rotation, the cutter shaft 54 defining the axis of rotation of the cutting blade 52, the swing plate 65 in contact with the tip of the cutter shaft 54, the stop 66, and the contact piece 67. When the pencil has been shaved to the designated pencil-core length, the tip of the pencil-core reaches and presses onto the contact piece 67. As a result, the stop 66 is pushed to move the lower end of the swing plate 65 engaged with the end of the stop 66. The swing plate 65 is mounted to be swingable about the tip of the connecting rod 64 as a pivot point, so that when swing plate 65 is moved by pressure applied to its lower end, the upper under thereof moves in the opposite direction. The tip of the obliquely oriented cutter shaft 54 in contact with the upper end of the swing plate 65 is therefore pushed back, i.e., rightward as viewed in FIGS. 2 and 3, thereby separating the cutting blade from the shaved surface of the pencil. The shaving operation is therefore discontinued and wasteful shaving avoided.

The wasteful shaving prevention mechanism will be explained in more detail. When the pencil-core tip adjustment dial 61 is turned to select the “Fine” setting, for example, the pencil-core tip adjustment screw 62 rotates to move the gear shaft 63 screw-engaged at the axial center of the pencil-core tip adjustment screw 62 leftward in FIG. 2, thereby moving the connecting rod 64 to position the contact piece 67 at the location corresponding the “Fine” setting of the pencil-core tip diameter. Power is turned on to start pencil shaving when a pencil is inserted into the insertion hole. When the pencil has been shaved until advancing to the location corresponding to “Fine,” the tip of the pencil-core reaches and presses onto the contact piece 67. As a result, one movable end of the swing plate 65 mounted at the tip of the connecting rod is pushed to cause the other end thereof to press against the tip of the cutter shaft 54, which moves in an interlocked manner to move the cutting blade 52 rightward, thereby separating the cutting blade from the shaved surface of the pencil being shaved.

The operating position when “Thick” is selected is shown in FIG. 3. When the pencil-core tip adjustment screw 62 is turned to “Thick,” the gear shaft 63 screw-engaged at the axial center of the pencil-core tip adjustment screw 62 moves rightward, so that the swing plate 65 is positioned obliquely by the connecting rod 64. As a result, the contact piece 67 is pushed out to the location corresponding to the “Thick” setting. The operation is the same as when the “Fine” setting is selected. Moreover, the wasteful shaving prevention mechanism adopted in this invention is similar to that taught by the aforesaid Ref. No. 2.

The core fragment removal mechanism 80 comprises the core fragment removal button 81 provided on the outer surface of the main unit cover, the gear shaft 63 constituted to slide as a whole in response to pressing of the button, the connecting rod 64 connected to the tip of the gear shaft 63, the swing plate 65 provided to be swingable at the tip of the connecting rod, and the stop 66 for stopping the pencil-core whose base is engaged with the swing plate and whose tip is provided with the contact piece 67 that contacts the pencil-core tip. When the button 81 is pressed, the pencil-core tip adjustment screw 62 and the gear shaft 63 inserted into the pencil-core tip adjustment screw 62 together move rightward in FIG. 2, thereby moving the connecting rod 64 rightward. As a result, the swing plate 65 at the tip of the connecting rod 64 moves rightward. Simultaneously, the stop 66 interconnected with the base of the swing plate 65 moves rightward to push the contact piece 67 rightward. As a result, any pencil-core fragment broken off during the sharpening operation and remaining inside the pencil sharpener can be pushed rightward in the drawing and ejected.

As set out in the foregoing, this embodiment enables the pencil-core tip adjustment mechanism 60 and the core fragment removal mechanism 80 to be implemented using many structural components in common. The electric pencil sharpener can therefore be made compact

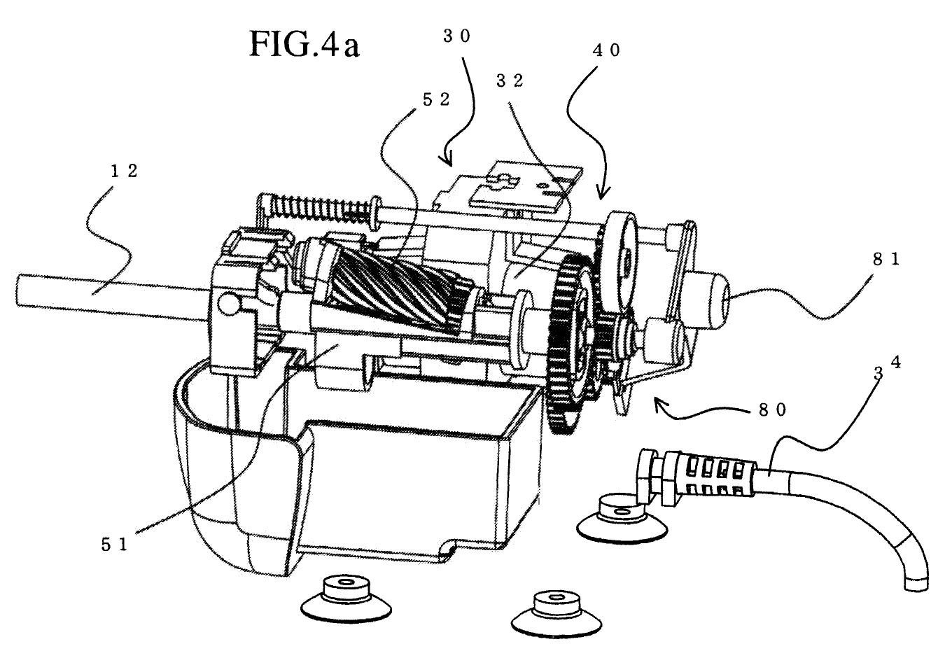

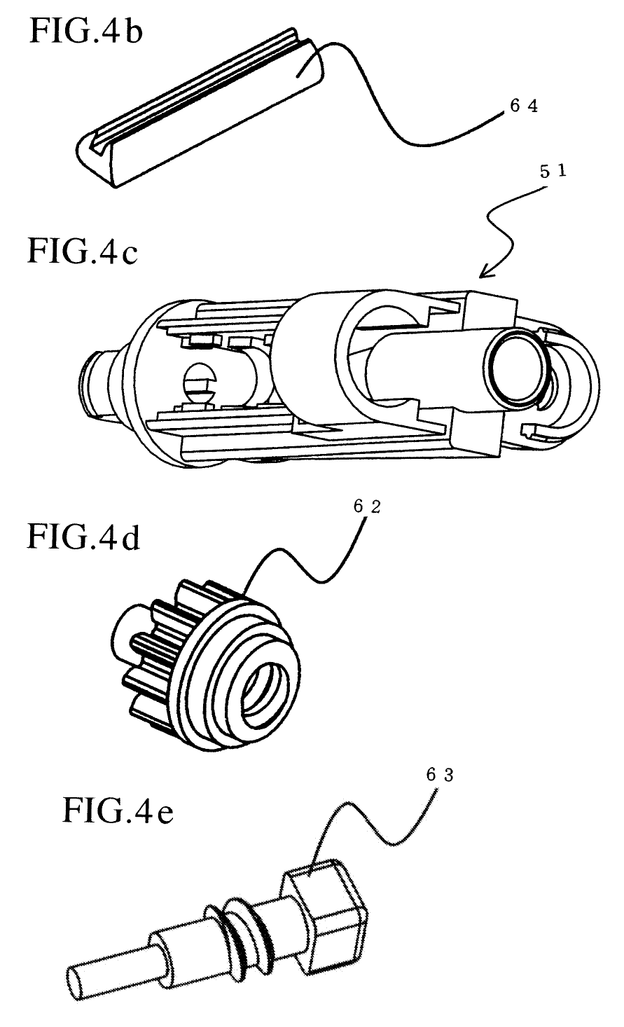

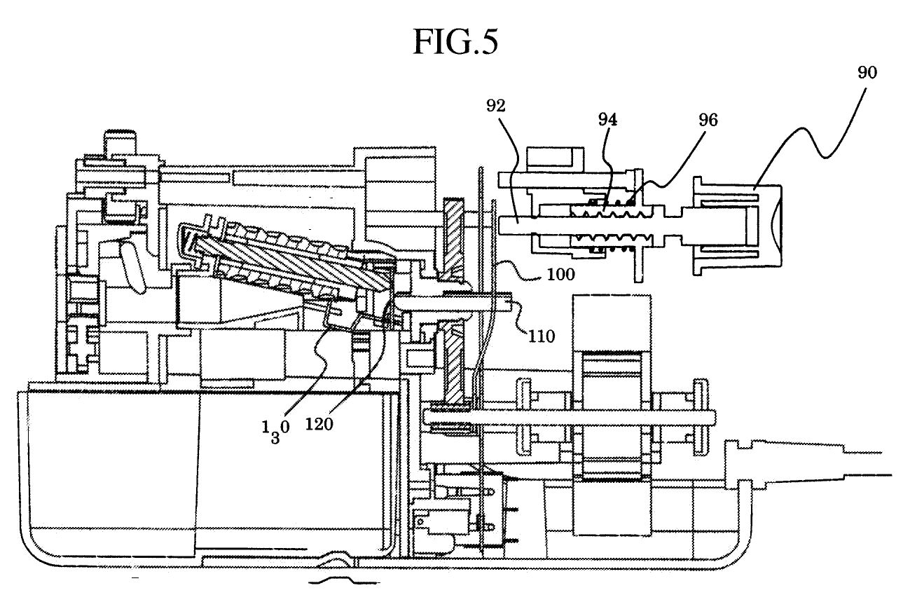

The core fragment removal mechanism of the electric pencil sharpener according to this invention is configured so that when the core fragment removal button 81 is pressed, the power is turned ON to operate the motor and rotate a cutter holder 51 (see FIGS. 4(a) and 4(b)) so that the cutting blade rotates to push out any broken off pencil-core fragment remaining on the side of the pencil insertion hole. Therefore, any broken-off core piece that should become lodged deep inside the sharpener and otherwise be hard to remove can be ejected in the direction of the pencil insertion hole. And when a short pencil or the like remains inside the cutter holder, it can be similarly removed from the pencil insertion hole.

### Second Embodiment

In a second embodiment of the present invention, the functions of the pencil-core tip adjustment mechanism 60 and the core fragment removal mechanism 80 are simultaneously enabled by a single operating unit. The electric pencil sharpener according to the second embodiment is the same in operating principle as the first embodiment but differs in structure, as explained in the following. As shown in FIG. 5, the pencil-core tip adjustment dial 61 and button 81 constituted as separate members in the first embodiment are structured unitarily as a pencil-core tip adjustment knob 90. (The orientation of the embodiment shown in FIG. 5 is reversed from that in FIG. 2.) When the pencil-core tip adjustment knob 90 is turned, the screw thread provided thereon causes it move inward and press against an engagement member 100. Since the engagement member 100 in turn presses against a shaft 110, the tip of the shaft 110 presses against the central region of a swing plate 120 whose one end is fixed to the cutter shaft. As a result, the swing plate 120 is swung so that its lower end presses against a stop 130, thereby moving the pencil contact position and enabling adjustment of the pencil-core thickness. When the stop 130 is pushed inward, its tip 92 moves a substantial distance together with a screw-engaged member 94, thereby enabling substantial movement of the interlocked stop 130. Therefore, any lodged pencil-core fragment can be removed by pushing the pencil-core tip adjustment knob 90. Further, since the screw-engaged member 94 is engaged with an elastic body 96, it returns to its original position when the pushing force is released. And since the pencil-core adjustment position is fixed by the screw thread, pressing the pencil-core tip adjustment knob does not affect the adjustment mechanism for changing the pencil-core thickness.

The structure of the second embodiment described in the foregoing enables the pencil-core tip adjustment mechanism and core fragment removal mechanism to be realized by the same set of members, so that the pencil sharpener can be given a simple appearance and minimized in size.

### Third Embodiment

A third embodiment of the present invention is imparted with various functions by configuring the switchbox for sensing a pencil inserted into the electric pencil sharpener as illustrated in the drawings.

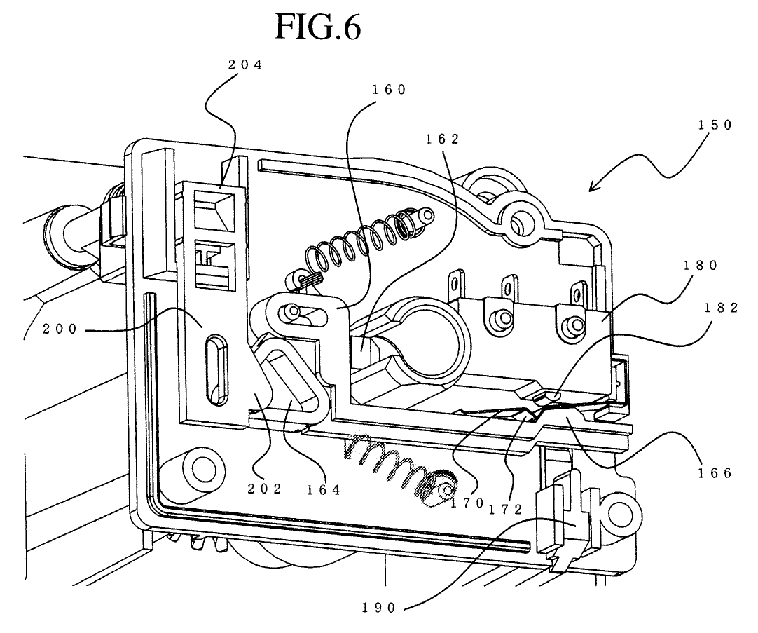

As shown in FIG. 6, a switchbox 150 comprises a pencil insertion zone switch lever 160, a switch plate 170, a switch 180, a shaving bin detector 190, and a switch lever 200.

The pencil insertion zone switch lever 160 is configured so that a projection protruding into the pencil insertion hole pushes it out of the hole horizontally upon entry of a pencil, thereby operating an insertion section switch 162. It has the general shape of the letter L and comprises a perforated section 164 formed with a hole and a switch lever projection 166.

The switch plate 170 is configured to press the terminal 182 of the switch 180 when a switch plate projection 172 thereof is pressed by the switch lever projection 166.

The switch 180 is connected to the current source and operates to turn the supply of current ON and OFF. The switch 180 is formed with the terminal 182. When the switch lever projection 166 of the switch plate 170 is raised (lowered), the switch plate projection 172 is pressed against (separated from) the terminal 182 to turn the power ON and OFF.

The shaving bin detector 190 presses the switch lever projection 166 of the pencil insertion zone switch lever 160 from underneath. Therefore, when the shaving bin is in place, the switch lever projection 166 is pressed upward and made capable of reliably pressing the switch plate projection 172 when it is slid laterally. However, when the shaving bin is not in place, the shaving bin detector 190 is in its downward position, so that the switch lever projection 166 of the pencil insertion zone switch lever 160 hangs free (i.e., has no support on the underside). This makes it impossible for the switch lever projection 166 to press the switch plate projection 172 even if it is slid laterally, and thus impossible to turn the switch on. Therefore, when the shaving bin is not in place, the electric pencil sharpener cannot operate even if a pencil is inserted. This safety feature ensures that the cutting blade will not be rotated when, for example, the user inserts a finger into the shaving bin section with the shaving bin is not properly in place.

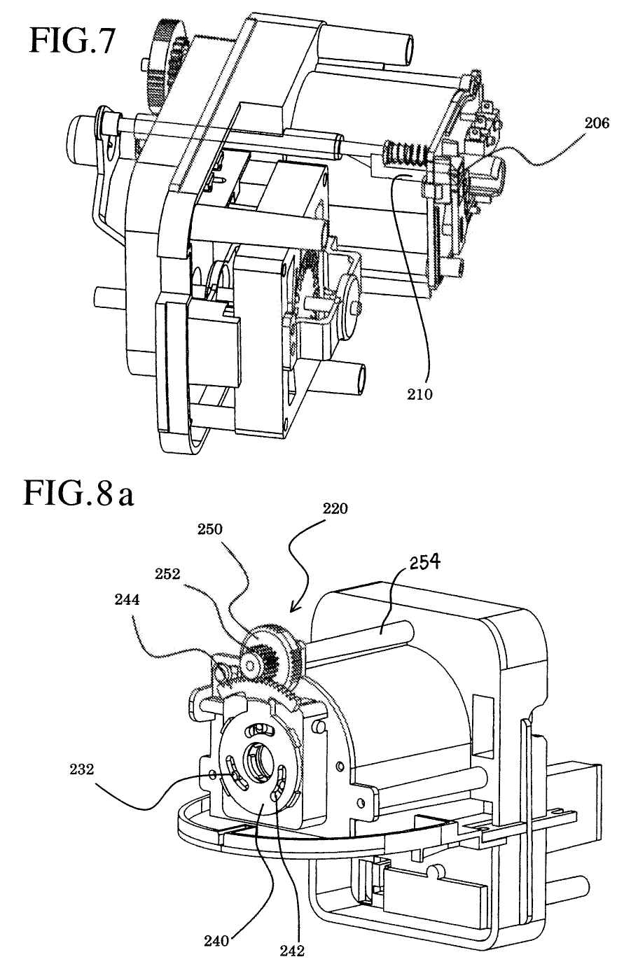

The switch lever 200 has its one end 202 inserted into the perforated section 164 of the pencil insertion zone switch lever 160. The other end 204 thereof is provided with a switch lever taper 206 formed in a tapered shape so as to make the switch lever 200 vertically movable by insertion/retraction of a switch shaft 210 (shown in FIG. 7). When the switch lever 200 is pressed by a core fragment removal button (not shown), the switch shaft 210 is forcibly inserted onto the switch lever taper 206 at the top of the switch lever 200, thereby raising the entire switch lever, including the one end 202 engaged with the perforated section 164. Therefore, even without inserting a pencil, the pencil insertion zone switch lever 160 can be forcibly slid laterally to cause the switch lever projection 166 to press the switch plate projection 172 and thus turn on the power. This supply of power with no inserted pencil present makes it possible to operate the electric pencil sharpener so as to drop any lodged pencil-core fragment into the shaving bin.

The perforated section 164 is not limited to the triangular shape of this embodiment. However, the triangular shape is preferable for forcibly turning the switch 180 ON by moving the switch lever 200 upward.

An elastic body is engaged with and fastened above the pencil insertion zone switch lever 160 and a second elastic body can be further installed on the underside of the switch lever 200. The elastic body or bodies ensure that the constituent components are reliably restored to their illustrated standby locations after an inserted pencil is removed following sharpening.

### Fourth Embodiment

In a fourth embodiment of the present invention, a pencil diameter adapter is incorporated to enable true center pencil sharpening.

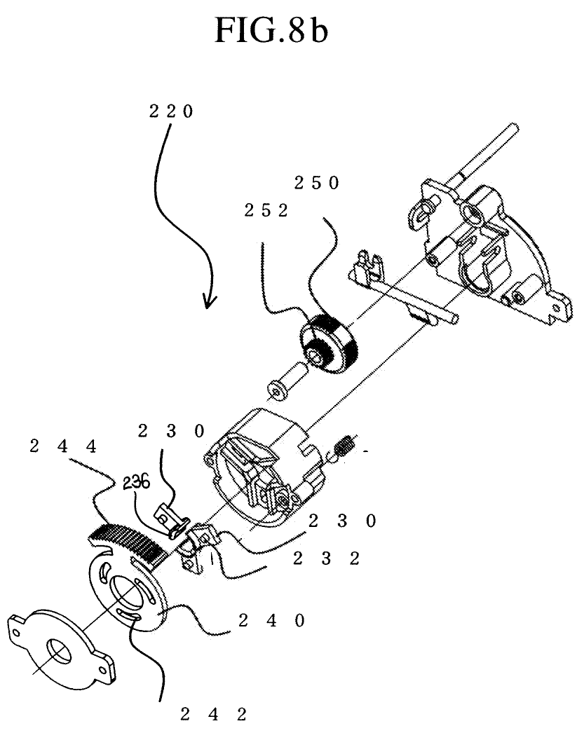

The pencil diameter adapter 220, best shown in FIGS. 8(a) and 8(b), comprises three slide plates 230, an adapter plate 240 and a pencil diameter adapter dial 250.

The slide plates 230 are adapted to press the pencil from three directions. Each slide plate 230 is formed with a projection 232 that is inserted into one of three engagement slots 242 of the adapter plate 240. In this embodiment, reliable pencil retention is enabled by providing the slide plates 230 with pressers 236 for pressing directly onto the pencil. The pressers 236 are flat plates that can be made to assume a curved shape defining the same diameter as the pencil.

The adapter plate 240 is formed with the engagement slots 242 for insertion of the projections 232 of the slide plate 230. The upper end of the adapter plate 240 is formed with a sector gear 244 for engagement with a gear of the pencil diameter adapter dial 250. The engagement slots 242 are formed as arcuate slots of the same arc angle whose centers are offset from one another. The opposite ends of the engagement slots are therefore at different distances from the center of rotation of the adapter plate 240. When the pencil diameter adapter dial 250 is turned, the rotation is transmitted through a gear 252 of a shaft 254 to and the adapter plate sector gear 244 to expand or contract the slide plate 230.

The pencil diameter adapter dial 250 is provided with the gear 252 engaged with the sector gear 244. It contracts and expands the diameter (pencil diameter) defined by the slide plates 230 when turned clockwise and counterclockwise.

The foregoing structure of the electric pencil sharpener according to the fourth embodiment enables true center pencil sharpening, so that the sharpened pencil has a neat appearance with no eccentric shaving.

What is claimed is:

1. An electric pencil sharpener comprising:
a main unit cover;
an electrically powered drive mechanism;
a rotation transmission mechanism;
a cutting mechanism equipped with a rotary cutting blade for rotationally shaving a pencil;
a wasteful shaving prevention mechanism for separating the rotary cutting blade from the pencil;
a pencil-core tip adjustment mechanism for adjusting the diameter of the shaved pencil-core tip; and
a core fragment removal mechanism for removing from the pencil sharpener any broken off pencil-core fragment remaining therein, in which electric pencil sharpener:
the wasteful shaving prevention mechanism includes a slidable cutting blade for obliquely contacting an inserted pencil to shave it from its tip end while executing planetary rotation, a cutter shaft constituting the cutting blade center shaft and a plate contacted by the distal end of the cutter shaft;
the pencil-core tip adjustment mechanism includes a pencil-core tip adjustment dial provided on the outer surface of the main unit cover for enabling selection of a pencil-core tip length, a pencil-core tip adjustment screw rotated by rotation of the dial, a gear shaft screw-engaged with the pencil-core tip adjustment screw to be movable in the axial direction, a connecting rod connected to the end of the gear shaft, a swing plate provided on the end of the connecting rod and a stop equipped with a contact piece that engages the base of the swing plate to cause the distal end thereof to contact the pencil-core tip; and
the core fragment removal mechanism includes a core fragment removal button provided on the outer surface of the main unit cover, said gear shaft fit into the pencil-core tip adjustment screw and structured to slide as a whole in response to pressing of the button, said connecting rod connected to the end of said gear shaft, said swing plate provided on the end of the connecting rod and said stop equipped with the contact piece that engages the base of said swing plate to cause the distal end thereof to contact the pencil-core tip.

2. An electric pencil sharpener comprising:
a main unit cover;
an electrically powered drive mechanism;
a rotation transmission mechanism;
a cutting mechanism equipped with a rotary cutting blade for rotationally shaving a pencil;
a wasteful shaving prevention mechanism for separating the rotary cutting blade from the pencil;
a pencil-core tip adjustment mechanism for adjusting the diameter of the shaved pencil-core tip; and
a core fragment removal mechanism for removing from the pencil sharpener any broken off pencil-core fragment remaining therein,
in which electric pencil sharpener:
the pencil-core tip adjustment mechanism and the core fragment removal mechanism are constituted as a unitary structure including a pencil-core tip adjustment knob structured to be both rotatable and depressible, an engagement member pressed by the distal end portion of the pencil-core tip adjustment knob, a shaft in turn pressed by the pressed engagement member, a plate that operates as a lever fixed at one point, and a laterally movable stop pressed by the lower end of the plate pressed by said shaft.

3. An electric pencil sharpener according to claim 1 or 2, wherein the wasteful shaving prevention mechanism has a structure whereby even when rotation of the pencil-core tip adjustment dial causes rotation of a pencil-core tip adjustment gear (formed integrally with a pencil-core tip adjustment internal gear), the gear shaft itself is moved to move the connecting rod, so that movement of the gear shaft moves the connecting rod to press the swinging end of the swing plate provided on the end of the connecting rod and interoperatively move the shaft of the cutting blade and thus move the cutting blade upward to separate the cutting blade from the shaved surface of the pencil being shaved, thereby preventing wasteful shaving.

4. An electric pencil sharpener according to claim 1 or 2, wherein the pencil-core tip adjustment screw of the pencil-core tip adjustment mechanism is formed at its center with a threaded through-hole and the gear shaft is fitted in the hollow through-hole to be movable in the axial direction.

5. An electric pencil sharpener according to claim 1 or 2, wherein the core fragment removal mechanism has a structure whereby pressing of the core fragment removal button turns power ON to cause a motor to rotate a cutter holder, thereby rotating the cutting blade to push any residual matter toward a pencil insertion hole and thus cause the residual matter to be propelled toward the pencil insertion hole.

6. An electric pencil sharpener comprising:
a main unit cover;
an electrically powered drive mechanism;
a rotation transmission mechanism;
a cutting mechanism equipped with a rotary cutting blade for rotationally shaving a pencil;
a wasteful shaving prevention mechanism for separating the rotary cutting blade from the pencil;
a pencil-core tip adjustment mechanism for adjusting the diameter of the shaved pencil-core tip; and
a core fragment removal mechanism for removing from the pencil sharpener any broken off pencil-core fragment remaining therein,
which electric pencil sharpener further comprises:
a switchbox capable of detecting an inserted pencil and including a substantially L-shaped pencil insertion zone switch lever adapted to be pushed horizontally by an inserted pencil and having a perforated section formed with a hole and a switch lever projection, a switch plate formed with a projection and adapted to press a switch terminal when pushed by the switch lever projection, a switch adapted to be turned ON to supply power when the terminal thereof is pressed by the switch plate, a shaving bin detector that presses the switch plate projection of the pencil insertion zone switch lever from underneath, and a switch lever formed with a switch lever taper, one end of which is inserted into the perforated section of the pencil insertion zone switch lever and the other end of which is taperedly cut away and pressed by a switch shaft to move vertically.

7. An electric pencil sharpener according to claim 6, wherein the perforated section of the pencil insertion zone switch lever has a generally triangular shape.

8. An electric pencil sharpener comprising:
a main unit cover;
an electrically powered drive mechanism;
a rotation transmission mechanism; and
a cutting mechanism equipped with a rotary cutting blade for rotationally shaving a pencil,
which electric pencil sharpener further comprises a pencil diameter adapter enabling true center sharpening irrespective of the thickness of an inserted pencil, the pencil diameter adapter including slide plates formed with projections and adapted to press the pencil from three directions, an adapter plate provided with arcuate engagement slots of the same arc angle whose centers are offset from one another and which are arranged to receive insertion of the projections formed on the slide plates and is provided at its upper end with a sector gear for engagement with a gear of an adapter lever, and the shaft formed with the gear for engagement with the sector gear.

9. An electric pencil sharpener according to claim 8, wherein the portions of the slide plates that press the pencil are flat plates that can be made to assume a curved shape matched to the diameter of the pencil.
